(19) United States
(12) Patent Application Publication
(10) Pub. No.: US 2008/0096175 A1
(43) Pub. Date: Apr. 24, 2008

(54) INDIVIDUALIZING STUDENT ACCESS TO EDUCATIONAL CONTENT

(76) Inventors: Ilne du Toit, Centurion Pretoria (ZA); Jacqueline Lampert, Denver, CO (US)

Correspondence Address: HARNESS, DICKEY, & PIERCE, P.L.C, 7700 BONHOMME, STE 400, ST. LOUIS, MO, 63105, US

(21) Appl. No.: 11/961,468

(22) Filed: Dec. 20, 2007

Related U.S. Application Data
(63) Continuation-in-part of application No. 11/334,517, filed on Jan. 18, 2006.

(30) Foreign Application Priority Data
May 27, 2005 (ZA) 200504352

(51) Int. Cl. G09B 5/00

(52) U.S. Cl. 434/308

(57) ABSTRACT

A system for providing educational content to a user includes an audiovisual medium via which presentation(s) included in a course offering are accessible as audiovisual content and as text content. The system is selectively promptable by a user via the medium to activate a plurality of expositions of aspects of the course offering, including aspects of the presentation(s), in a plurality of different modes of exposition. This system makes it possible for an individual student to optimize his/her approach to educational content in order to make use of the most effective ways in which that student learns.

### CROSS-REFERENCE TO RELATED APPLICATIONS

This application is a continuation-in-part of U.S. patent application Ser. No. 11/334,517 filed Jan. 18, 2006 and entitled Educational Systems and Methods, which, in turn, claims the benefit of South African Provisional Application No. 2005/04352 filed May 27, 2005, and entitled Educational Material. The disclosures of the above applications are incorporated herein by reference in their entireties.

### FIELD

The present disclosure relates to educational content and more particularly (but not exclusively) to providing educational content and access to the content in various ways that are selectable by a student to facilitate learning.

### BACKGROUND

The statements in this section merely provide background information related to the present disclosure and may not constitute prior art.

Teachers in schools, universities, and other learning environments know that students can vary widely in their abilities to learn materials presented in the classroom. Students also vary in how they most effectively absorb the materials presented. Some students, for example, are pictorially and/or textually oriented while others may learn best by hearing the material. Variation in learning rates also can result from language differences. For example, a student attending a class given in a language other than his or her native tongue may need to expend additional effort to master the material.

When a student takes a correspondence course or is otherwise remote from the classroom, face-to-face communication between a teacher and the student typically is not available. The learning process can be difficult for a student who is compelled to cover the course material alone and in ways that do not play to his/her learning strengths.

### SUMMARY

The present disclosure, in one implementation, is directed to a method of preparing educational content for use by a student. A plurality of educational presentations is included in a course offering. At least one of the presentations is made accessible as audiovisual content via an audiovisual medium and is made accessible as text content via the audiovisual medium. The method includes providing via the audiovisual medium a plurality of expositions of aspects of the course offering, including aspects of the presentation(s); and providing via the audiovisual medium a plurality of prompts selectable by a user of the audiovisual medium for activating the expositions in a plurality of modes of exposition relative to the contents.

In another implementation, the disclosure is directed to a method of providing educational content to a user. A course is offered that includes a plurality of lectures. At least one of the lectures is made accessible as audiovisual content and as text content via an audiovisual medium. The method includes providing via the audiovisual medium a plurality of expositions of aspects of the course offering, including aspects of those lecture(s) made accessible. The method also includes providing via the audiovisual medium a plurality of prompts for accessing the expositions with reference to the contents and via a plurality of modes of access, and making the course offering and the audiovisual medium available to the user.

In another implementation, the disclosure is directed to a system for providing educational content to a user. The system includes an audiovisual medium via which at least one presentation included in a course offering is accessible as audiovisual content and as text content. The system is selectively promptable by a user via the medium to activate a plurality of expositions of aspects of the course offering, including aspects of the at least one presentation, in a plurality of different modes of exposition.

In yet another implementation, the disclosure is directed to a method of providing educational content to one or more students. A plurality of educational presentations is included in a course offering. At least one of the presentations is made accessible as text content and as audiovisual content via an audiovisual medium. A plurality of prompts are configured relative to the text and audiovisual contents, the prompts selectively activatable by a student via the audiovisual medium to dynamically supplement rendition of one or more of the contents with a plurality of expositions as to portions of the contents, each exposition activatable in one or more of a plurality of different modes of exposition. The course offering and audiovisual medium are provided to each of the one or more students.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a conceptual diagram of a system for providing and/or delivering educational content in accordance with one implementation of the disclosure; and

FIG. 2 is a flow diagram of a method of preparing educational content for use by a student in accordance with one implementation of the disclosure.

### DETAILED DESCRIPTION

The following description is merely exemplary in nature and is not intended to limit the present disclosure, application, or uses.

In the present disclosure, various methods and systems are described by which an educational institution or other educational content provider may provide educational content to students and/or other users who may or may not be remote from the content provider. A student who is taking a course can access educational materials provided for the course in various ways which allow the student to individualize his/her learning process. In such manner, a student may utilize ways to learn the materials that work best for that student.

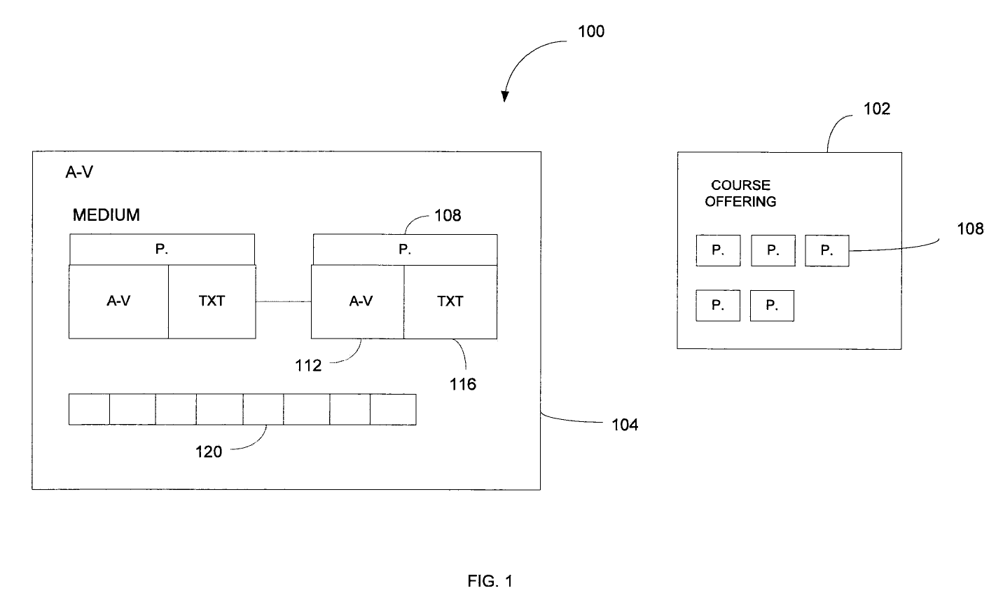

One implementation of a system for providing and/or delivering educational content to a student or other user is indicated generally in FIG. 1 by reference number 100. An educational content provider may provide a course offering, indicated conceptually in FIG. 1 by reference number 100, e.g., to students or other users who register for the course. The system 100 includes at least an audiovisual medium, indicated conceptually by reference number 104, via which educational content may be provided to a student or other user as further described below. In some implementations, educational content may be provided in one or more additional forms, e.g., as one or more course-related textbooks, study guides, study plans, course outlines, and/or course instructions. In various implementations, the educational content relates to a topic that a student or other person wishes to learn. The content may include materials to be learned in a course offered for educational credit. In some implementations, at least portions of the system 100 may be provided as a kit to a student or other user.

Although the word “medium” may be used in the singular form in the present disclosure and claims, the word “medium” may be used to refer to more than one item and/or to more than one type of item. For example, in some embodiments, the audiovisual medium 104 includes one or more digital video discs (DVDs). The DVD(s) may be delivered, e.g., to a student who registers for a given course offering. In some implementations, the DVD(s) may be played on a computer. In other or additional implementations, the DVD(s) may be played on other or additional types of DVD player, e.g., using a television set as a display.

In other embodiments, the audiovisual medium 104 can include other or additional media, including but not limited to the Internet, an intranet, and/or other network. Thus, in some configurations, a user may use a computer and a browser program to access, e.g., a web page or other Internet address at which educational content may be made available. In some implementations of the present disclosure, a portable media player, e.g., an iPod® by Apple, Inc., could be used. Reference is made to various implementations of systems and methods for delivering educational content described in U.S. patent application Ser. No. 11/334,517 filed Jan. 18, 2006, published as U.S. Patent Application Publication 20060286535 on Dec. 21, 2006, the disclosure of which is incorporated herein by reference in its entirety.

A plurality of presentations 108 is included in the course offering 102, although in various implementations, a course could be offered that includes a single presentation. Presentations may include (without limitation) lectures, e.g., by faculty of the provider of the course offering, demonstrations, tours, interviews, etc. Presentations are typically provided in a sequential order, although for some course offerings, presentations could be provided in a different order (or in no particular order). In the system 100, the presentations 108 have been recorded and are accessible via the audiovisual medium 104 as audiovisual content 112 and also as text content 116. It should be noted generally that the term “audiovisual” may be used to audio content, visual content, and/or audiovisual content. Although typically both audio and video would be provided in the recording of a presentation, it is contemplated that an audio version and/or a video version with captioning could be provided in some implementations.

A plurality of prompts 120 is provided via the medium 104. In various implementations, and as further described below, a student or other user of the system 100 may selectively use the prompts 120 to activate a plurality of expositions of aspects of the course offering 102. An exposition may be or include (without limitation) an explanation, e.g., of a term or concept presented in the audiovisual content 112 and/or text content 116. Additionally or alternatively, an exposition could be or include a translation, e.g., of part or all of the audiovisual content 112 and/or text content 116. Additionally or alternatively, an exposition could include (a) a test of student comprehension of all or part of the course offering, and/or (b) provision of an answer key to a test.

As one example, a student may prompt the system 100 to provide a definition of a term previously used in a presentation 108 accessed by the student via the medium 104. Expositions of various course aspects may be in various modes of exposition, including but not limited to pop-ups, hyperlink destinations, captions, video segments, audio segments, audiovisual segments, and/or text segments. Expositions may be in the same form as or in a form different from that of the content to which it relates. For example, a student could activate a text prompt while viewing text content 112, to cause an audiovisual exposition to be provided. In the present example, the student may prompt the system 100 to provide the definition to the student as text and/or as audiovisual content.

It should be noted that in various implementations, prompts 120 are not necessarily made available in a single location as shown in FIG. 1. At least some (if not all) prompts 120 are made available dynamically to a user of the medium 104. For example, a user may be presented with one or more buttons, hyperlinks, and/or hot zones activatable by a computer mouse. Additionally or alternatively, a user may be presented with a DVD and/or computer menu from which one or more items may be selected. It should be understood that many types of prompts may be used which are not limited to the foregoing examples. Prompts thus are selectively activatable by a student via the medium 104 to dynamically supplement rendition of the audiovisual and/or text contents (112 and/or 116) with one more expositions as described above.

Referring again to FIG. 1, when, e.g., a student user of the medium 104 wishes to access a presentation 108, he/she may select and watch and/or listen to the audiovisual content 112, e.g., on a DVD player, television monitor, and/or computer display. Additionally or alternatively, the user may select the text content 116 for reading. Dependent on the audiovisual medium, the student may be allowed to selectively switch between the text and audiovisual contents 112 and 116 and/or to play both contents 112 and 116 together, e.g., on a split screen. In some implementations, printed material may appear behind a lecturer in a video presentation of a lecture. The printed material may, for example, highlight key points of the lecture. Additionally or alternatively, the student may select a menu item or other prompt displayed via the medium 104 for printing the text content 116, e.g., on a printer connected to the student's computer or at a remote location. In such manner, a student may obtain a printed transcript of, e.g., a lecture and have the printed transcript available for viewing while listening to the lecture as audiovisual content 112.

In some implementations, a student may activate one or more screen icons displayed at the end of a lecture to obtain a printed transcription of the lecture. Printed transcriptions of a lecture could be made available in other languages besides the language in which the lecture is delivered by the lecturer. For example, a student who is a native speaker of French might select a French transcript of a lecture delivered in English. Of course, transcriptions in other languages, e.g., Spanish, Chinese, German, etc., could be provided.

A student may wish to have all or part of a lecture translated into another language while the student is watching the lecture. Accordingly and in some implementations, the student may select one or more prompts 120 to activate captioning in a selected language. In such manner, captions may be added to a video rendition of one or more presentations 108. Adding captions could include activating one or more or closed captions and/or adding open captions.

Pop-ups and/or hyperlink destinations may be used in numerous ways to provide information dynamically to a student. For example, during a lecture or demonstration, a teacher may initially define a term or concept and subsequently refer to it one or more times during the remainder of the presentation and/or in a subsequent presentation 108. In various implementations, a button or menu item may be provided in the audiovisual content 112 by which a student may cause a definition of the term or concept to be textually displayed as a pop-up while the audiovisual content 112 continues to be displayed or is paused. Where the text content 116 for a given lecture or other type of presentation 108 refers to a particular term or concept, a hyperlink may be provided that is selectable to direct the student to a definition of the term or concept. It will be appreciated that being able to view pop-ups and/or follow hyperlinks during the course of a presentation 108 can allow a student to obtain information previously provided in the presentation, without having to replay the presentation. In some implementations, when a student activates language captioning as described above, information provided in pop-ups and/or at hyperlink destinations may be provided in the same selected language.

In various implementations, prompts 120 for displaying one or more sample tests may be provided via the medium 104. Thus, e.g., where the course is offered for academic credit based on a student's passing of one or more tests of knowledge of the course content, the student may be provided with an opportunity to view and/or take one or more practice tests. Such tests may have been given in one or more previous offerings of the course. A multiple-choice test could be graded, and the student could be given the test results and an answer key, essentially instantaneously upon completion of the test by the student. For essay-type tests, an example of a passing essay could be provided to the student for comparison by the student.

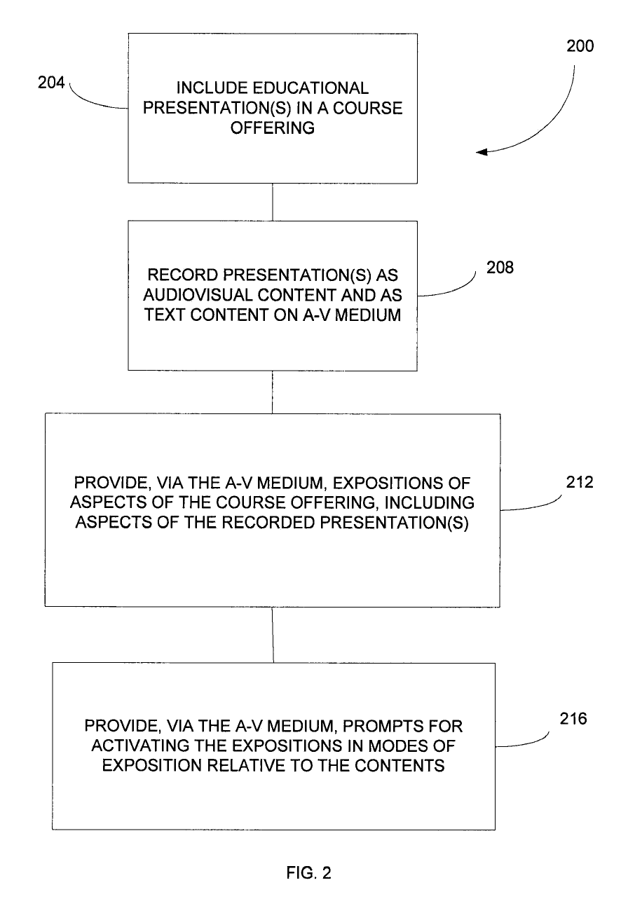

One implementation of a method of preparing educational content for use by a student is indicated generally in FIG. 2 by reference number 200. The method 200 may be performed, e.g., by a college, university, high school, trade school, or other provider and/or preparer of educational content. In process 204, the content provider includes one or more educational presentations in a course offering. The course offering may be of many different types, including but not limited to a course offered for educational credit. Presentation(s) included in the course offering may include, e.g., one or more lectures and/or demonstrations given by faculty, teaching staff, and/or other presenter(s) of educational material. In process 208, at least one of the presentation(s) is recorded as audiovisual content and as text content on an audiovisual medium. In process 212, a plurality of expositions of aspects of the course offering, including aspects of the recorded presentation(s), is provided via the medium. In process 216, a plurality of prompts is provided via the medium for activating the expositions in a plurality of modes of exposition relative to the contents. Each of the prompts is selectively activatable by a user of the medium, e.g., by a student registered for the course offering. It should be noted generally that the term “process” may be used in the disclosure and claims to refer to a single operation or a plurality of operations. It also should be noted that performance of the foregoing processes is not necessarily sequential.

The foregoing systems and methods can provide a holistic way of reaching students. Individual students can be provided with a learning environment providing multiple modes of access to educational content. Each student can manipulate such an environment to advantage. An individual student can optimize his or her approach to educational content in order to make use of the most effective ways in which that student learns.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A method of preparing educational content for use by a student, the method comprising:
including a plurality of educational presentations in a course offering;
making at least one of the presentations accessible as audiovisual content via an audiovisual medium and making the at least one of the presentations accessible as text content via the audiovisual medium;
providing via the audiovisual medium a plurality of expositions of aspects of the course offering, including aspects of the at least one of the presentations; and
providing via the audiovisual medium a plurality of prompts selectable by a user of the audiovisual medium for activating the expositions in a plurality of modes of exposition relative to the contents.

2. The method of claim 1, wherein providing a plurality of prompts comprises providing one or more prompts for selectively switching between renditions of the audiovisual content and the text content.

3. The method of claim 1, wherein providing a plurality of expositions comprises providing one or more of the following: an explanation, a translation, and a test of student comprehension of at least part of the course offering.

4. The method of claim 3, wherein providing an explanation comprises providing a definition of a concept referred to in the course offering.

5. The method of claim 4, wherein a mode of exposition includes at least one of a popup and a hyperlink destination.

6. The method of claim 3, wherein providing a translation comprises adding captions to at least one of the video content and a pop-up.

7. The method of claim 3, wherein providing a test of student comprehension comprises providing an answer key for the test.

8. The method of claim 1, further comprising offering the course offering and audiovisual medium to a user.

9. The method of claim 1, wherein the audiovisual medium includes at least one of the following: a digital video disk (DVD), a computer, and a network site.

10. A method of providing educational content to a user, the method comprising:
offering a course that includes a plurality of lectures;
making at least one of the lectures accessible as audiovisual content and as text content via an audiovisual medium;
providing via the audiovisual medium a plurality of expositions of aspects of the course offering, including aspects of the at least one of the lectures;
providing via the audiovisual medium a plurality of prompts for accessing the expositions with reference to the contents and via a plurality of modes of access; and
making the course offering and the audiovisual medium available to the user.

11. The method of claim 10, wherein the expositions include an explanation of a concept referred to in the at least one of the lectures, the method comprising providing, at each of one or more references to the concept in the audiovisual content, a prompt to display the explanation.

12. The method of claim 11, wherein the prompt includes at least one of the following: a menu item, a button, a hot zone, and a hyperlink.

13. The method of claim 10, wherein the expositions include translation of at least part of the at least one of the lectures, the method comprising providing at least one prompt for displaying translation captions relative to the audiovisual content.

14. The method of claim 10, wherein the expositions include one or more tests of comprehension of one or more parts of the course offering, the method comprising providing one or more prompts for displaying the one or more tests.

15. The method of claim 10, further comprising providing one or more prompts for printing one or more parts of the text content.

16. A system for providing educational content to a user, the system comprising an audiovisual medium via which at least one presentation included in a course offering is accessible as audiovisual content and as text content;
the system selectively promptable by a user via the medium to activate a plurality of expositions of aspects of the course offering, including aspects of the at least one presentation, in a plurality of different modes of exposition.

17. The system of claim 16, selectively promptable to present at least part of one of the contents until prompted to present at least part of the other content.

18. The system of claim 16, wherein the audiovisual medium comprises at least one of the following: a digital video disk (DVD), a computer, and a network site.

19. The system of claim 16, wherein the different modes of exposition comprise at least two of the following: a popup destination, a hyperlink, a caption, a video segment, an audio segment, and a text segment.

20. A method of providing educational content to one or more students, the method comprising:
including a plurality of educational presentations in a course offering;
making accessible at least one of the presentations as text content and as audiovisual content via an audiovisual medium;
configuring a plurality of prompts relative to the text and audiovisual contents, the prompts selectively activatable by a student via the audiovisual medium to dynamically supplement rendition of one or more of the contents with a plurality of expositions as to portions of the contents, each exposition activatable in one or more of a plurality of different modes of exposition; and
providing the course offering and audiovisual medium to each of the one or more students.

21. The method of claim 20, wherein the modes of exposition include two or more of the following: a popup, a hyperlink destination, a caption, a video segment, an audio segment, and a text segment.

22. The method of claim 21, wherein the modes of exposition include a popup, the method further comprising:
including in the popup a definition of a concept included in the at least one of the presentations; and
displaying the popup in at least one of the contents, when activated via a prompt displayed in at least one of the contents.
